(19) United States
(12) Patent Application Publication
(10) Pub. No.: US 2016/0014459 A1
(43) Pub. Date: Jan. 14, 2016

(54) SYSTEM AND METHOD FOR STRATEGIC CHANNEL PLACEMENT BASED ON PURCHASING INFORMATION

(71) Applicant: MasterCard International Incorporated, Purchase, NY (US)

(72) Inventor: DEBASHIS GHOSH, Charlotte, NC (US)

(73) Assignee: MasterCard International Incorporated, Purchase, NY (US)

(21) Appl. No.: 14/330,519

(22) Filed: Jul. 14, 2014

(51) Int. Cl. H04N 21/462; H04N 21/266

(52) U.S. Cl. CPC H04N 21/462; H04N 21/266

(57) ABSTRACT

Various embodiments provide systems and methods for leveraging transaction processing data to identify areas or subject matters of interest to consumers, e.g., in a particular cable viewing area/region. Such data can be correlated to cable channels, for example, that provide programming related to or commensurate with the identified areas of interest. Media providers and/or cable networks that provide such programming, for example, may then opt for placement of cable channels directed to the identified areas of interest in locations or slots within a channel lineup with promote increased viewership.

### TECHNICAL FIELD

The present disclosure is generally related to electronic transaction processing. More particularly, the present disclosure is directed to systems and methods for leveraging electronic transaction processing data to provide channel placement recommendations.

### BACKGROUND

The use of payment cards for a broad spectrum of cashless transactions has become ubiquitous in the current economy, accounting for hundreds of billions of dollars in transactions during a single year. For example, MasterCard International Incorporated, one example of a payment card network, processes upwards of 160 million transactions per hour across 230 countries. However, leveraging accumulated data from such transactions for, e.g., advertising, marketing, and/or similar purposes has traditionally been limited to targeted advertising for specific products/services. Moreover, increased consumer concerns for privacy and security of personal information provide barriers to the use of such data.

### SUMMARY

In accordance with one embodiment, a method for achieving strategic placement of a channel comprises generating reporting regarding financial transaction payments associated with a subset of consumers. The method further comprises correlating information in the reporting with a channel relevant to the financial transaction payments. Moreover, the method comprises placing the channel in a channel lineup slot that promotes viewership of the channel.

In accordance with another embodiment, a non-transitory computer-readable medium has computer executable program code embodied thereon. The computer executable program code is configured to cause a computer system to collect financial transaction payment information associated with a plurality of consumers, and define at least one microsegment representative of a subset of the plurality of consumers. The computer executable program code is further configured to cause the computer system to perform statistical analysis on the financial transaction payment information of the at least one microsegment to identify at least one subject matter of interest relevant to the at least one microsegment, and correlate the at least one subject matter of interest with a media channel. Upon completing the identification, the computer executable program code is configured to cause the computer system to place the media channel in a media channel lineup slot that promotes viewership of the media channel.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 is a block diagram illustrating an example system architecture of a financial transaction processing system in accordance with various embodiments.

FIG. 2 is an example dataset illustrating useable consumer data without including personally identifiable information in accordance with various embodiments.

FIGS. 3A and 3B are example datasets illustrating microsegments created from the dataset of FIG. 3 in accordance with various embodiments.

FIG. 4 is a block diagram illustrating an example dataset for use with the disclosed systems and methods in accordance with various embodiments.

FIG. 5 is a flow chart illustrating example processes performed for generating microsegments without the use of personally identifiable information in accordance with various embodiments.

FIG. 6 is a block diagram illustrating an example system architecture of channel placement system in accordance with various embodiments.

FIG. 7 is a flow chart illustrating example processes performed for achieving strategic channel placement based on purchasing information in accordance with various embodiments.

FIG. 8 illustrates an example computing module that may be used in implementing features of various embodiments.

The drawings are described in greater detail in the description and examples below.

### DETAILED DESCRIPTION

The details of some example embodiments of the methods and systems of the present disclosure are set forth in the description below. Other features, objects, and advantages of the disclosure will be apparent upon examination of the following description, drawings, examples and claims. It is intended that all such additional systems, methods, features, and advantages be included within this description, be within the scope of the present disclosure, and be protected by the accompanying claims.

At the onset of cable television, cable networks often jockeyed for position in a cable channel lineup, in particular, to be placed or slotted within the first 10 to 15 slots. Placement among the lower channel slots would often translate into better viewer exposure and ratings for channels as opposed to channels placed higher in the cable channel lineup. That is, viewers would often begin their viewing experience by “surfing” the cable channel lineup beginning at channel 1 or 2, thereby allowing for increased exposure of those cable channels with lower channel placement. With the ever increasing amount of cable programming, the number of cable channels has ballooned into the thousands. Accordingly, channel placement with respect to neighboring channels has also become of import to media providers. That is, the placement of channels proximate to “anchor” channels can also lead to increased exposure. Anchor channels as utilized herein can refer to established or otherwise known/popular channels that traditionally have high viewership, including, but not limited to, CBS, ABC, NBC, CNN, etc.

Various embodiments provide systems and methods for leveraging transaction processing data to identify areas or subject matters of interest to consumers, e.g., in a particular cable viewing area/region (which can be based on geographical boundaries, for example, as is the case with media providers such as Cox® Communications, Comcast® Corporation, etc.). Such data can be correlated to cable channels, for example, that provide programming related to or commensurate with the identified areas of interest. Media providers and/or cable networks that provide such programming, for example, may then opt for placement of cable channels proximate to an anchor channel. It should be noted that placement near any desired channel, whether an anchor channel or not, is contemplated herein. That is, certain viewing regions may have a particular channel, not a traditional anchor channel, that experiences high viewership, and placement near such a channel would prove advantageous as well.

User equipment, such as a television, set-top box, receiver, etc. may receive content in the form of signals from a media source over one or more communications paths. A media source can be, e.g., a cable system headend, a satellite media distribution facility, a media broadcast facility, and the like. The media source may transmit signals over one or more wired and/or wireless communications paths, e.g., via satellite, fiber-optic network, coaxial cable network, etc. Such signals can carry media content such as, television/cable programming, web services, etc. For example, the media source may transmit media as one or more channels of television/cable programming.

The user equipment may include one or more mechanisms for viewing such programming or services, as well as an electronic program guide (EPG) that may list such programming or services in an interactive fashion. For example, all cable channels provided to a particular region may be listed and allowed to be browsed and/or selected for viewing by a viewer.

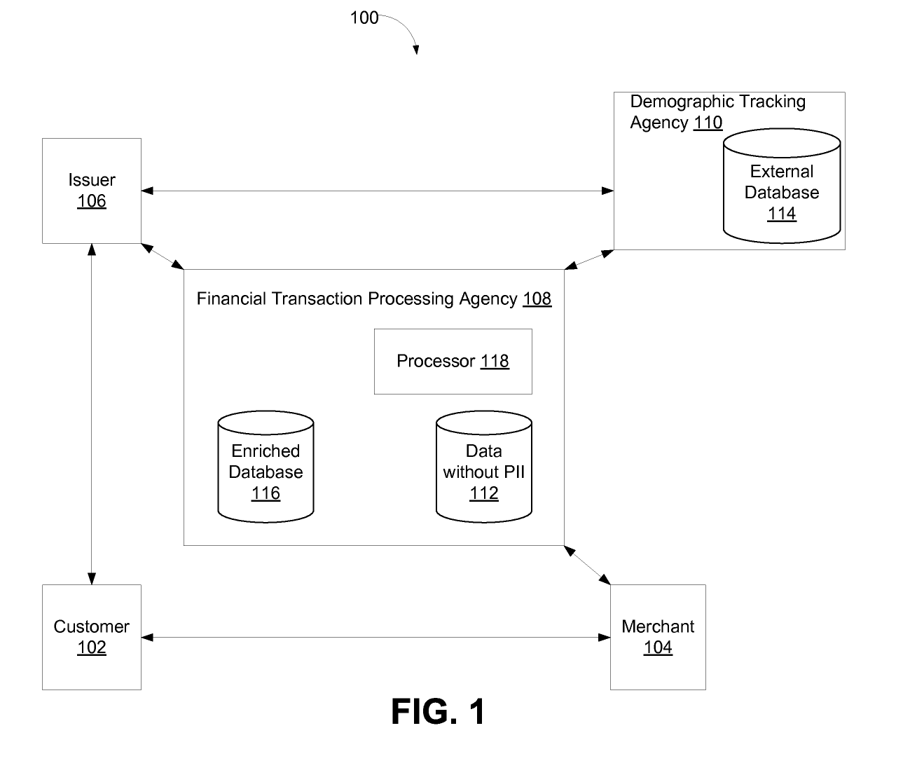

FIG. 1 illustrates an example financial transaction processing system 100 including a customer (e.g., a consumer) 102, a merchant 104, an issuer 106, a financial transaction processing agency 108, and a demographic tracking agency 110.

Customer 102 may use a payment card at the merchant 104 for payment of a financial transaction. The payment card may be any type of transaction card used for making payments in a financial transaction, such as a debit card, credit card, charge card, ATM card, etc. Each payment card may be assigned a unique identifier (e.g., an account number) that links the payment card to a cardholder (e.g., customer 102). It should be noted that a payment card can also refer to some proximity payment device (utilized on its own or incorporated into another device such as a mobile telephone, personal digital assistant (PDA), etc.) having near field communications (NFC) capabilities, such as a radio frequency identification (RFID) chip implemented therein. A payment card can further refer to virtual or limited use account numbers and electronic wallets. It should also be noted that the payment card may be utilized to effectuate payment for a product or service remotely, e.g., via an online payment, where the unique identifier and/or other relevant information can be input on a computing device.

Merchant 104 may forward the payment card information (e.g., the account number) as well as transaction information (e.g., the amount, merchant information, time and date information, etc.) to financial transaction processing agency 108 for processing. Financial transaction processing agency 108 may be any service provider for merchants, acquirers, issuers, consumers, etc. for the processing of transactions involving payment cards, such as MasterCard International Incorporated, the assignee of the present disclosure. Financial transaction processing agency 108 may issue an authorization request from issuer 106. Issuer 106 may be an entity (e.g., a bank or merchant 104) that issued the payment card used in the transaction, a stand-in processor configured to act on behalf of the issuer of the payment card, a credit bureau that has card or consumer related information, or any other suitable entity.

Issuer 106 may approve or deny the transaction. If issuer 106 approves the transaction, issuer 106 notifies financial transaction processing agency 108 of the approval. Financial transaction processing agency 108 may then notify merchant 104 of the approval of the transaction, who may then finalize the transaction with customer 102. Issuer 106 may then bill customer 102 for payment of the transaction and report any payments, or lack thereof, to demographic tracking agency 110 (e.g., a credit report agency, a marketing and research firm such as Nielsen Media Research, etc.). Demographic tracking agency 110, therefore, may possess personally identifiable information (PII) of customer 102, which may be stored in external database 114, though financial transaction processing agency 108 would not be in possession of the PII or have access to it.

PII may be information that can be used, alone or in conjunction with other sources, to uniquely identify a single individual (e.g., customer 102). As such, there is a benefit to prevent the use and dissemination of PII in an effort to protect consumer privacy and to prevent against crimes, such as identity theft. The present disclosure provides for systems and methods of leveraging financial transaction processing data, where financial transaction processing agency 108 (e.g., MasterCard) need not necessarily possess any data containing PII in processes that help accurately identify groups of individuals or businesses having particular interests or desires across a broad and diverse population of cardholders. In accordance with some embodiments, however, if customers and/or merchants are so inclined, and through authorization and/or enrollment in, e.g., an appropriate data sharing mechanism, PII can be revealed and used.

This is done, viewed at a high level, by enriched data associated with individuals or businesses (entities), to include transaction history and demographics, but not PII, as associated by a unique identifier, and placing like entities, filtered by some criteria, into small groups. If third parties, such as a media provider, have additional information regarding the entities (e.g., contact information associated with a cable subscription account), such additional information can be, e.g., grouped and matched to enriched data groups or datasets. Whether or not the groups from the combined/enriched datasets and from the datasets have parity, common members, or no overlap, statistically, the matched groups have predictable behavior, particularly in small groups or microsegments (as defined below). Having grouped the third party's dataset members into small groups based on selected activities and/or characteristics (e.g., demographic and geographic information), the third party can target the interests of these small groups or microsegments by channel placements, as described herein. It should be noted that the additional information, e.g., contact information, that may include PII can be removed from the third party dataset or can otherwise be made unavailable to financial transaction processing agency 108.

In some embodiments, bucketing may be used in order to render potentially identifiable information anonymous, such as by aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers, and thus no longer be personally identifiable to that consumer. In other embodiments, encryption may be used. For example, personally identifiable information (e.g., an account number) may be encrypted (e.g., using a one-way encryption) such that financial transaction processing agency 108 may not possess the PII or be able to decrypt the encrypted PII. It should be noted that various methods may include periodic and/or aperiodic repetition of various processes described herein to obtain the latest/most relevant statistics, groupings, microsegments, etc. so that channel placement remains relevant.

Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc.

As illustrated in FIG. 1, financial transaction processing agency 108 may include a database without PII 112 and an enriched database 116, which also does not include PII. Demographic tracking agency 110 may include an external database 114, which may include PII not accessible by financial transaction processing agency 108.

Database without PII 112 may store information on a plurality of consumers (e.g., the customer 102) that is not personally identifiable. For example, financial transaction processing agency 108 may store information relating to financial transactions processed by the agency as it processes transactions in system 100, such as transaction amount, transaction time, transaction location, merchant identification, etc. and do so without the use of any PII relating to customer 102 participating in the transactions. In some embodiments, database without PII 112 may store an encrypted unique identifier associated with a consumer, which may be encrypted using a one-way encryption, such that the financial transaction processing agency 108 may be unable to identify the associated consumer. Methods of encryption suitable for performing the functions as disclosed herein will be apparent to persons having skill in the relevant art.

Financial transaction processing agency 108 may communicate with demographic tracking agency 110 (e.g., via a network). Financial transaction processing agency 108 may obtain non-personally identifiable information included in external database 114. Non-personally identifiable information included in external database 114 may include geographical data, demographic data, financial data, or any other suitable data as will be apparent to persons having skill in the relevant art, hereinafter referred to generally as demographic data. In one embodiment, the information included in external database 114 may be bucketed and thus not personally identifiable. Financial transaction processing agency 108 may combine the non-personally identifiable information provided by demographic tracking agency 110 with information included in database without PII 112 into a single dataset. The combined dataset may be stored in enriched database 116. In some embodiments, financial transaction processing agency 108 may aggregate (e.g., bucket, group, etc.) data in each of external database 114 and database without PII 112 prior to combining the information into a single dataset. In a further embodiment, financial transaction processing agency 108 may aggregate data to a level of ten prior to combining the information into a single dataset.

Each of databases 112, 114, and 116 may be any type of database suitable for the storage of data as disclosed herein. Each database may store data in a single database, or may store data across multiple databases and accessed through a network. Network configurations as disclosed herein may include a local area network (LAN), a wide area network (WAN), a wireless network (e.g., WiFi), a mobile communication network, a satellite network, the Internet, fiber optic, coaxial cable, infrared, radio frequency (RF) or any other suitable configuration as would be apparent to persons having skill in the relevant art.

Data may be stored on any type of suitable computer readable media, such as optical storage (e.g., a compact disc, digital versatile disc, blu-ray disc, etc.) or magnetic tape storage (e.g., a hard disk drive). A database may be configured in any type of suitable database configuration, such as a relational database, a structured query language (SQL) database, a distributed database, an object database, etc. Suitable configurations and database storage types will be apparent to persons having skill in the relevant art.

Database without PII 112 and enriched database 116 may be included as part of financial transaction processing agency 108 either internally or externally, and accessed through a network. Similarly, external database 114 may be included as part of demographic tracking agency 110 internally or externally, and accessed through a network. Each database may be a single database, or may comprise multiple databases which may be interfaced together (e.g., physically or via a network). In some embodiments, database without PII 112 and enriched database 116 may be a single database.

Financial transaction processing agency 108 may include a processor 118, which may be any type of processing device capable of performing the functions as disclosed herein, such as a computer configured as disclosed herein to become a specific purpose computer, etc. The processing device may be a single system (e.g., a single specific purpose computer) or may be comprised of several interconnected (e.g., physically or through a network) systems or servers (e.g., a server farm). Processor 118 may be coupled to each of databases 112, 114, and 116 either physically (e.g., through a cable such as a coaxial cable, fiber-optic cable, etc.) or through a network.

Processor 118 may be configured to receive information from both database without PII 112 and enriched database 116, to receive information with the PII removed from external database 114, and to combine the data to form a combined dataset without PII. In some embodiments, processor 118 may aggregate the information received from at least one of the two databases prior to combining the information into the combined dataset. Processor 118 may also be configured to store the combined dataset (e.g., that does not include PII) in enriched database 116. Processor 118 may be further configured to review the combined dataset or to select microsegments or audiences based on the combined dataset, as discussed in more detail below. In some embodiments, processor 118 may be configured to review selected microsegments and/or audiences and generate reports therein.

A microsegment as utilized herein can refer to a representation of a group of consumers that is granular enough to be valuable to advertisers, marketers, etc., but still maintain a high level of consumer privacy without the use or obtaining of any PII. The definition and creation of microsegments, as well as example microsegment datasets are described in: U.S. patent application Ser. No. 13/437,987, filed Apr. 3, 2012, for “Protecting Privacy in Audience Creation” by Curtis VILLARS et al.; U.S. patent application Ser. No. 13/438,346, filed Apr. 3, 2012, for “Method and System for Measuring Advertising Effectiveness Using Microsegments” by Curtis VILLARS et al.; and U.S. patent application Ser. No. 13/554,402, filed Jul. 20, 2012, for “System and Method for Protecting Consumer Privacy in the Measuring of the Effectiveness of Advertisements” by Curtis VILLARS et al., each incorporated herein by reference in their entirety.

Microsegments may be given a minimum or a maximum size. A minimum size of a microsegment would be large enough so that no one entity could be personally identifiable, but small enough to provide the granularity needed in a particular circumstance. In some instances, the size of a microsegment may be dependent on the application. An audience (e.g., customers/consumers) based on a plurality of microsegments, for instance, might have ten thousand entities, but the microsegments would be aggregated when forming the audience and would not be discernable to anyone having access to an audience. As noted elsewhere, the entities in a microsegment used to form an audience might not be members of a resulting audience at all. In one embodiment, a microsegment may include at least ten unique entities. Microsegments may be defined based on geographical or demographical information, such as age, gender, income, marital status, postal code, income, spending propensity, familial status, etc. Categories, as alluded to previously, may be bucketed to avoid the use of PII (e.g., representing age by a range of ages). Again, microsegments may be defined by a plurality of geographical and/or demographical categories. For example, a microsegment may be defined for any cardholder with an income between $50,000 and $74,999 and that is between the ages of 20 and 29, and is single.

In this way, microsegments may be defined in such a way as to avoid the use of PII. For example, if a preliminary microsegment is defined for entities with an income between $100,000 and $149,999 in a particular postal code, and the preliminary microsegment contains less than a minimum number (e.g., as provided by governmental regulations, etc.) or entities, the preliminary microsegment may be combined with another microsegment (e.g., one corresponding to a neighboring postal code) as to further protect the personal identity of the entities in the preliminary microsegment. Thus, microsegments will be defined in a way so that no entity in any microsegment is personally identifiable.

Microsegments may also be based on behavioral variables. For example, database without PII 112 may store information relating to financial transactions. The information may be used to determine an individual's likeliness to spend and/or where an individual spends or is likely to spend money. An individual's spending habits may be represented generally, or with respect to a particular industry (e.g., electronics), retailer (e.g., Macy's®), brand (e.g., Apple®), or any other criteria which may be suitable as will be apparent to persons having skill in the relevant art. An individual's behavior may also be based on additional factors such as time, location, season, etc. For example, a microsegment may be based on consumers who are likely to spend on electronics during the holiday season, or on consumers whose primary expenses are in a suburb, but are likely to spend on restaurants located in a major city. The factors and behaviors identified and used to define microsegments may vary widely and may be based on the application of the information.

Behavioral variables may also be applied to generated microsegments based on the attributes of the entities in the microsegment. For example, a microsegment of specific geographical and demographical attributes (e.g., single males in a particular postal code between the ages of 26-30 with an income between $100,000 and $149,999) may be analyzed for spending behaviors. Results of the analysis may be assigned to the microsegment. For example, the above microsegment may be analyzed and reveal that the entities in the microsegment have a high spending propensity for electronics and may be less likely to spend money during the month of February.

In accordance with various embodiments described herein, information regarding such behavior, likeliness to spend, etc. can be leveraged to determine an audience's viewing preferences. The audience's viewing preferences may then be used to determine optimal channel placement in a particular region.

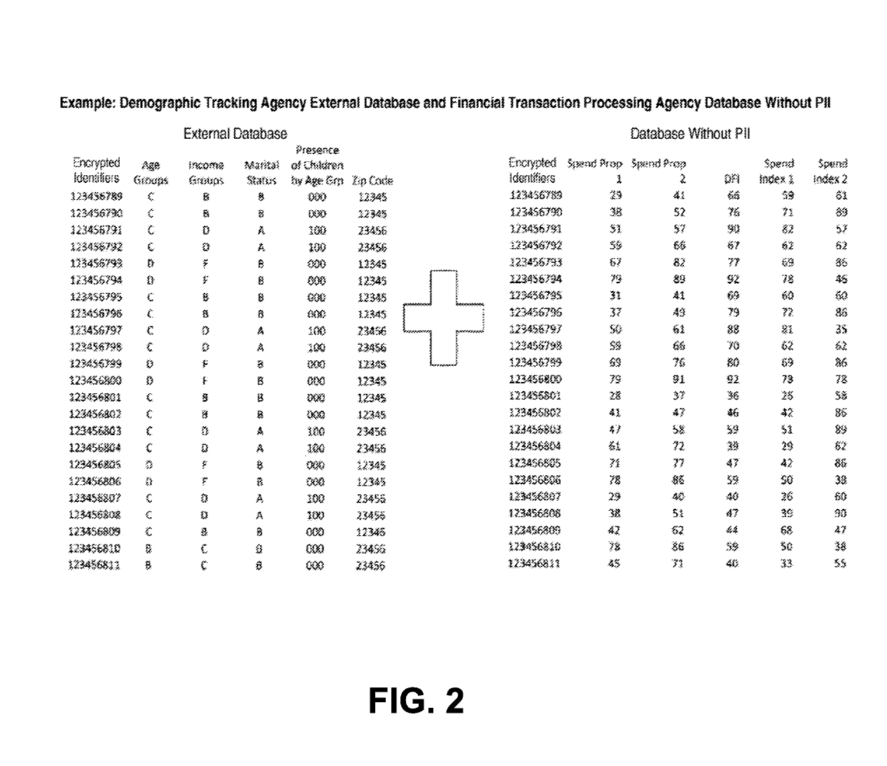

FIG. 2 illustrates example consumer information data that may be used in the creation of a microsegment. The data represented in the six leftmost columns may be information that is stored in external database 114 at demographic tracking agency 110, with any included PII removed or made otherwise inaccessible to financial transaction processing agency 108 or processor 118, in order to protect consumer privacy. The data represented in the six rightmost columns may be information that is stored in database without PII 112 within financial transaction processing agency 108. In the illustrated embodiment, there is a unique identifier for each consumer that has been encrypted in order to protect the anonymity of the consumer.

The data from external database 114 and the data from database without PII 112 may be combined into a single set of data that does not contain PII, which may be stored in enriched database 116. Information may be combined by use of the unique encrypted identifier for each entity. In one embodiment, if only one set of data contains a particular identifier, then that data may be left out of the enriched dataset. In some embodiments, only some of the columns of data may be included in the enriched dataset. For example, the marital status column may not be included (e.g., because marital status may not be relevant to a particular determination).

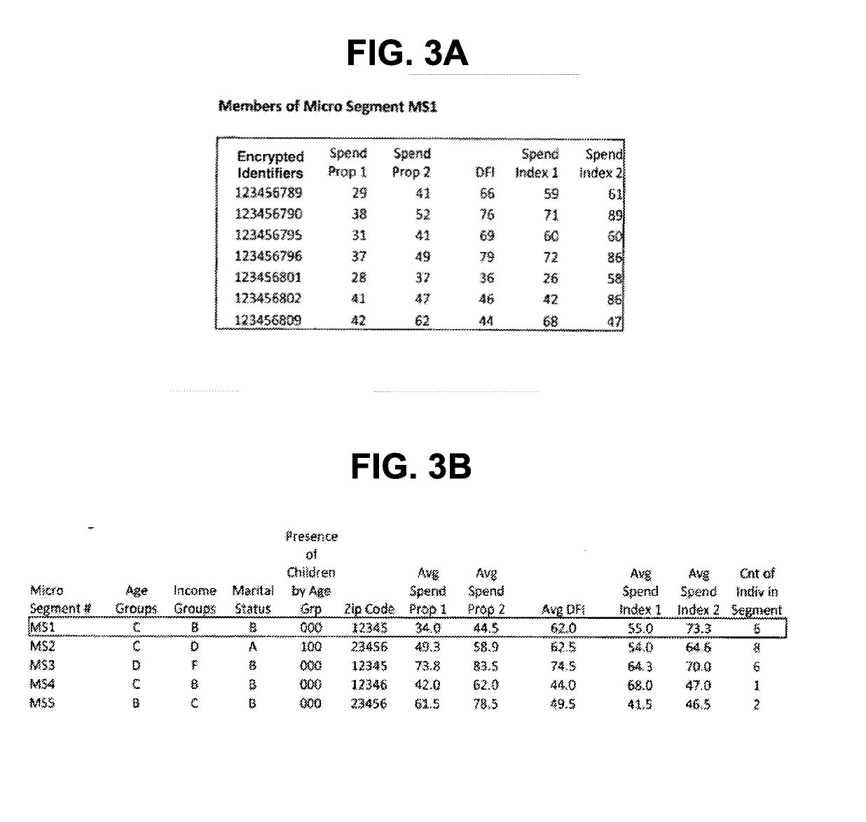

The enriched dataset may be stored in enriched database 116. The enriched data may be separated into a plurality of microsegments, with each microsegment being defined by at least one geographical or demographical limitation. FIG. 3A illustrates the dataset of individuals in a microsegment MS1, one of a plurality of microsegments illustrated in FIG. 3B. Microsegment MS1 includes seven individuals, each with a unique encrypted identifier. As illustrated in FIG. 3B, microsegment MS1 is defined by individuals in age group C, income group B, with marital status B, and living in postal code 12345. Groupings (e.g., age group C) are defined in bucketed groups in such a manner so as to not divulge any personally identifiable information. In this way, consumers of an ideal age may be placed into a microsegment (e.g., for determining purchasing habits and/or areas of interest) without financial transaction processing agency 108 knowing the actual age of a consumer or even a range of ages, and therefore protecting the privacy of the consumer. The corresponding values for the grouping (e.g., ages 25 to 34 corresponding to age group C), may not be available to financial transaction processing agency 108.

As illustrated in FIG. 3B, preliminary microsegment MS4 contains only a single individual. As a result, preliminary microsegment MS4 may be combined with another microsegment in order to protect the privacy of that individual. For example, preliminary microsegment MS4 may be combined with microsegment MS1, because preliminary microsegment MS4 is defined by the same age, income, and marital groups, and the defined postal code is a neighboring postal code. It will be apparent to persons having skill in the relevant art that microsegments may be grouped or combined in any manner that may be suitable for a particular application. For example, a cable network or media provider may want to place a particular channel near an anchor channel to capture or increase viewership for the particular channel in a particular postal code without regard for age or income, and therefore may desire to combine microsegment MS1 and microsegment MS3 based on the purchasing habits of customers in that postal code. Another retailer may want to target a specific age group without regarding for other factors, and therefore would want to combine microsegments MS1, MS2, and MS4.

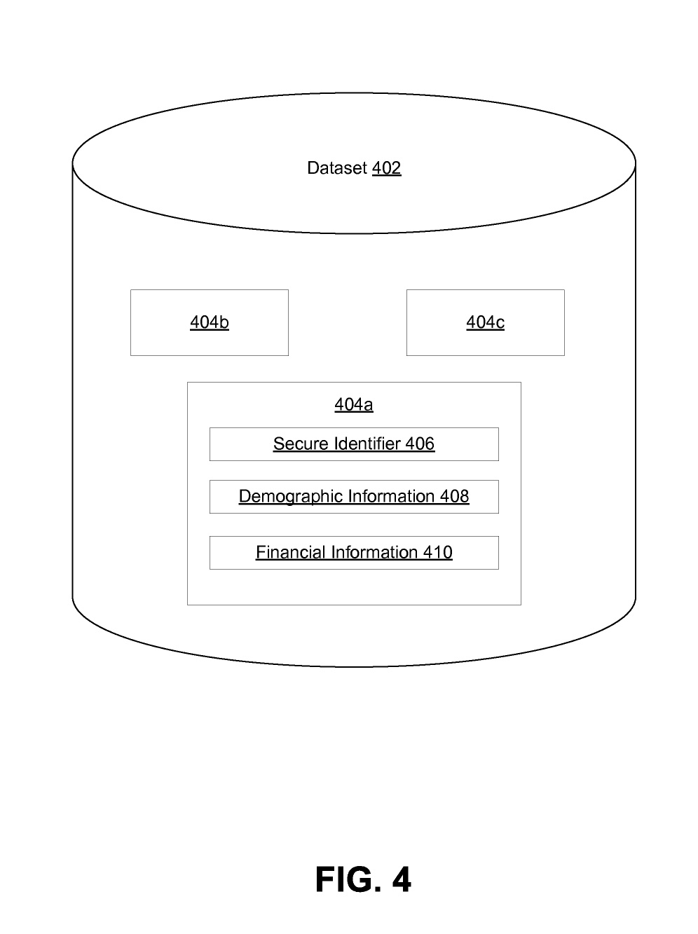

FIG. 4 illustrates an exemplary dataset 402 for the storing, reviewing, and/or reporting of a plurality of microsegments. In one embodiment, the dataset 402 may be reported to a third party, such as a media provider, as will be described herein.

The dataset 402 may contain a plurality of entries (e.g., entries 404a, 404b, and 404c). Each entry of the plurality of entries may include a secure identifier 406, demographic information 408, and financial information 410. Secure identifier 406 may include any type of identifier that may be unique to the particular entry (e.g., entry 404a). The secure identifier may be encrypted. Suitable encryption methods may include public key encryption, RSA encryption, XOR encryption, SHA-2 encryption, symmetric key encryption, etc. In an exemplary embodiment, the secure identifier may be encrypted using a one-way encryption process. The secure identifier may be encrypted in such a way as to make any PII unavailable to the financial transaction processing agency 108.

Demographic information 408 may include any demographic, geographic, or other suitable information relevant to the particular application. For example, demographic information may include familial status if a media provider or cable network is launching a cooking/food-related channel and is requesting or would find informative, information regarding microsegments of families with a propensity to spend money in restaurants or merchants that deal in cooking products. As another example, demographic information may include age, where such age-related demographic information may be useful to a media provider that provides children's programming. In some embodiments, the demographic information 408 may be replaced by geographic or other information. For example, rural areas would likely be populated by customers that may have an interest(s) in the areas of agriculture, hunting, etc. Accordingly, a media provider would be more apt to vie for/pay additional money to secure placement of a weather channel or outdoor channel in such areas. Suitable types of information relevant for the selecting and supplying of microsegments will be apparent to persons having skill in the relevant art. Likewise, financial information 410 may include any financial information relevant to the particular application. For example, a dataset provided to a media provider that provides a cooking channel may contain entries with financial information that includes spending propensity information associated with restaurants and/or merchants that sell cooking products.

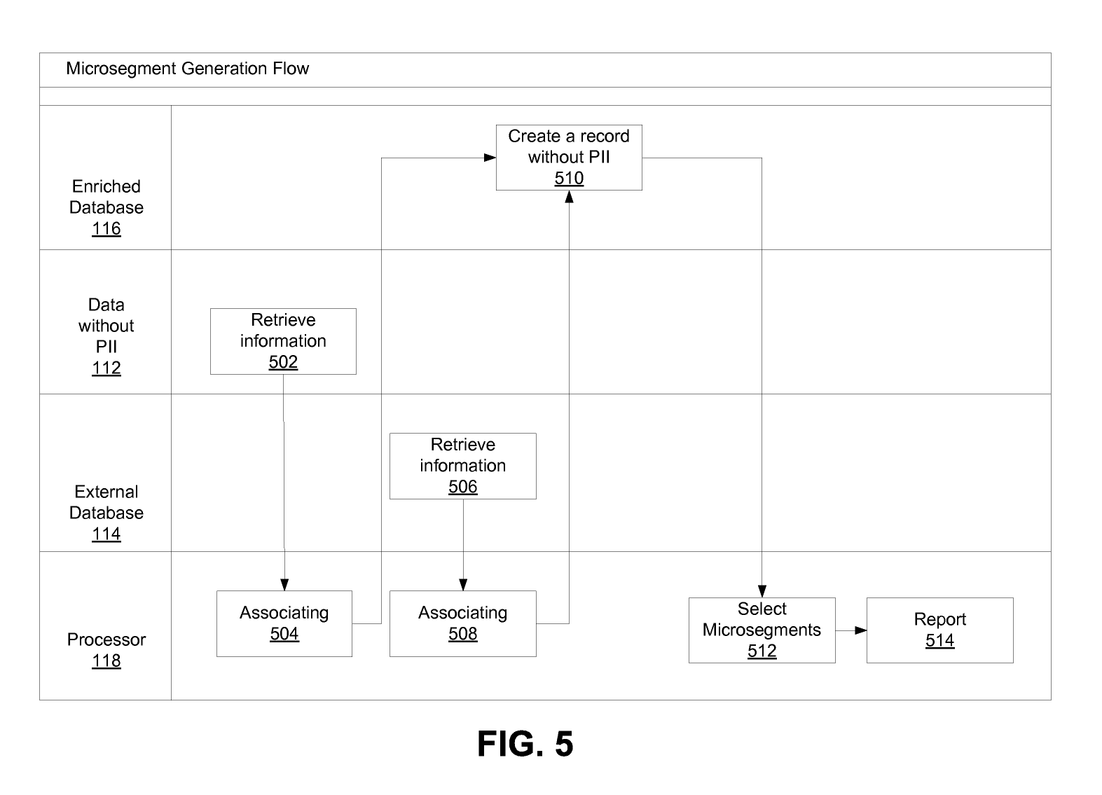

FIG. 5 illustrates example operations/processes performed in accordance with various embodiments for generating microsegments without the use of personally identifiable information. The operations/processes are disclosed with reference to processor 118, database without PII 112 and enriched database 116 as part of financial transaction processing agency 108, and external database 114 as part of demographic tracking agency 110.

Information that is stored in database without PII 112 may be retrieved (e.g., by processor 118) at operation 502. In one embodiment, all of the information stored in database without PII 112 may be retrieved. In another embodiment, only a single entry in database without PII 112 may be retrieved. The retrieval of information may be performed a single time, or may be performed multiple times. In an exemplary embodiment, only information pertaining to a specific microsegment (discussed further below) may be retrieved from database without PII 112.

At operation 504, the retrieved information may be associated with an entity (e.g., a cardholder, a business, a microsegment, any group or combination thereof, etc.) by processor 118. In one embodiment, each entity may be represented by a unique identifier, such as a unique identification number (e.g., an account number). In one embodiment, entity information may be encrypted.

Processor 118 may retrieve, at operation 506, information (e.g., that does not include any personally identifiable information) from external database 114. The retrieval performed at operation 506 may be of the same type and retrieve the corresponding information (e.g., relating to the same microsegment) as the information retrieved from database without PII 112 at operation 502. In one embodiment, if external database 114 includes PII, financial transaction processing agency 108 may be prohibited from accessing the PII. The information retrieved during this operation may, at operation 508, then be associated with an entity (e.g., the same entity from operation 502). At operation 510, a record may be created in enriched database 116. Enriched database 116 may store the information obtained and associated during prior operations. As a result, financial transaction processing agency 108 may not be in contact with or have access to any PII during the process.

Processor 118 may select microsegments, at operation 512, based on the information that was obtained and stored in enriched database 116. The selection of information for representation in the microsegment or microsegments may be different in every instance. In one embodiment, all of the information stored in enriched database 116 may be used for selecting microsegments. In an alternative embodiment, only a portion of the information may be used. The selection of microsegments may be based on specific criteria relevant to any application.

At operation 514, information may be reported by processor 118. Reporting may include the review and/or reporting of the selected microsegments, of the information stored in enriched database 116, or a combination thereof. Reviewing may include a review of financial account information of the entities in the microsegments, performing statistical analysis on financial account information, finding correlations between account information and consumer behaviors, predicting future consumer behaviors based on account information, relating information on a financial account with other financial accounts, or any other method of review suitable for the particular application of the data, which will be apparent to persons having skill in the relevant art. In a one embodiment, statistical analysis may be performed on the financial data for specific microsegments stored in enriched database 116 in order to determine the placement of one or more media channels in a geographically-based channel lineup of a service provider.

The report may be transmitted to a third party (e.g., a cable network or media provider) or financial transaction processing agency 108, displayed (e.g., on a display device), or may be reported in any other manner suitable for reporting. The reporting may include a report on a review of the selected microsegments or information, or any other suitable information, such as an analysis of the review (e.g., and performed by financial transaction processing agency 108). Reporting may be performed visually, aurally, tactically, or in any other suitable method as will be apparent to persons having skill in the relevant art.

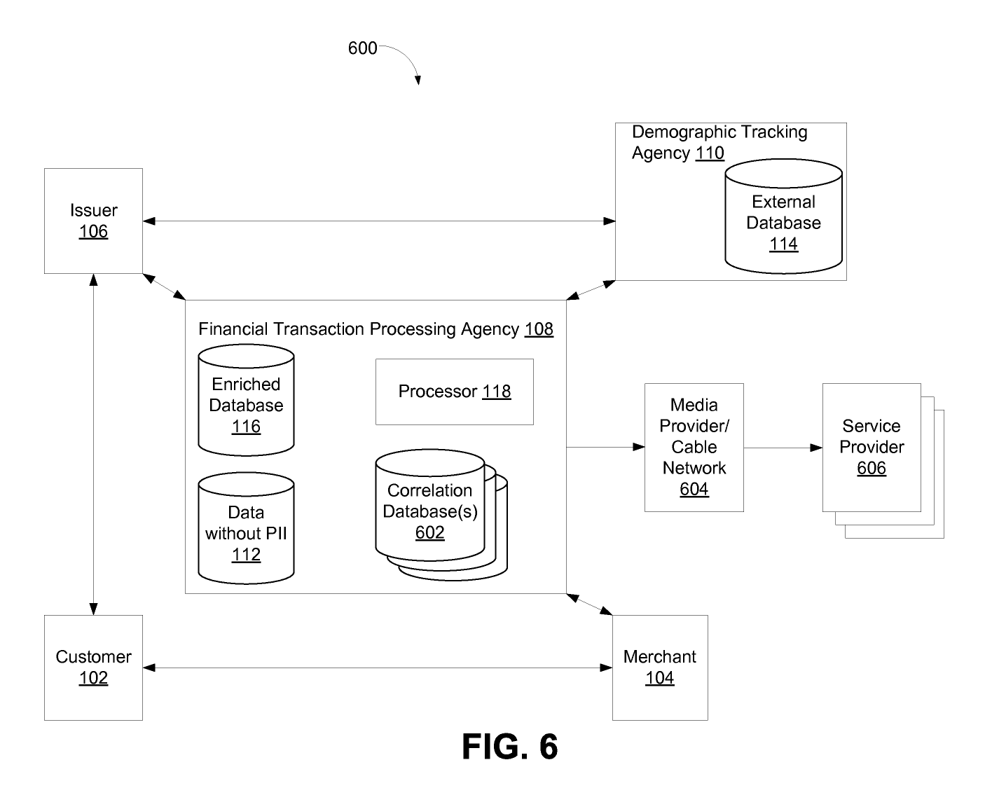

FIG. 6 illustrates an example system 600 for channel placement based on purchasing information in accordance with various embodiments. System 600 may include a customer (e.g., a consumer) 102, a merchant 104, an issuer 106, a financial transaction processing agency 108, and a demographic tracking agency 110. Additionally, financial transaction processing agency 108 may further include one or more correlation databases 602, which processor 118 may access to determine areas or subject matters of interest relevant to a particular microsegment or group(s) of microsegments. Such areas or subject matters of interest may then be mapped to known cable channels or programming by financial transaction processing agency 108 and/or by a media provider/cable network 604.

Media provider 604 may be a network or similar entity that provides programming, such as one or more channels directed to a particular subject matter of interest, e.g., cooking, hunting, motor sports, sports entertainment (e.g., wrestling and mixed martial arts), foreign/ethnic-specific news and/or programming, etc. Media provider 604 may receive reporting that includes or is related to financial transaction processing information, demographic and/or geographical information, and/or microsegments as described above. Based on the received reporting, media provider 604 may interact with one or more service providers 604, such as regional, national, or other cable or multimedia service providers to determine or vie for channel placement in a channel lineup of a service provider 606.

In particular, and in accordance with one embodiment, microsegments may be defined or based upon behavioral variables, as described above. Thus, a particular region may be identified as having consumers 102 that have spent and/or are likely to spend money with respect to a particular industry, such as the fishing industry. This can be determined by information captured by financial transaction processing agency 108 indicating that such customers have a propensity to spend money at a local retailer such as Bass Pro Shops®.

Correlation database(s) 602 may be, e.g., a relational database that maps keywords and/or other identifiers associated with a merchant, retailer, venue, etc. to subject matters of interest. In the case of purchases made at a Bass Pro Shops® merchant, the keyword “bass” may be used to map such a purchase to the subject matter “fishing.” Within the same correlation database 602, or by accessing another correlation database, the subject matter “fishing” may be correlated with a known fishing or outdoor programming channel, such as the Outdoor Channel®. For example, correlation database 602 may have one or more keywords associated with known channels, such that matching of one or more keywords obtained from purchase information with one or more keywords associated with known channels can reveal a channel that presents programming directed to the subject matter of interest.

It should be noted that processor 118 may execute one or more statistical and/or analytical algorithms to accomplish such correlation/matching. For example, an analytical algorithm may be used to determine that while the keyword bass may be related to fishing as well as to bass guitars. Based on information gathered by financial transaction processing agency 108, the keyword bass may be distinguished in this instance from guitars with knowledge of the location of the merchant at which a transaction took place.

Alternatively and because financial transaction processing agency 108 is already associated with merchants in terms of processing payment transactions on behalf of the merchants, merchant information maintained by transactions processing agency 108 may be supplemented by associative keywords or identifiers. For example, associative keywords can be keywords that identify products and/or services that may be purchased or provided at that merchant. It should be noted that the granularity or specificity of associative keywords or other information associated with a merchant can be configured as desired.

Alternatively still, the aforementioned correlation between purchasing information and programming channel may be achieved without necessarily resorting to reporting based on microsegments. That is, financial transaction processing agency 108 may analyze payment transactions to determine merchants and merchant locations at which payments are processed. Using only this information, financial transaction processing agency 108 may provide reporting, e.g., statistical trends, to media provider 604 that suggests purchasing habits within a particular region.

Armed with the above reporting, media provider 604 may opt to vie for or pay additional money to service provider 606 for placement of a channel relevant to a microsegment or group of consumers within, e.g., a particular geographical region, proximate to an anchor channel or other known popular channel in a channel lineup for that particular geographical region. That is, to continue the above example, the Outdoor Channel® may opt to pay additional money to have its channel(s) slotted next to NBC or CNN in a region(s) where it has been determined that microsegments or groups of consumers in that region make frequent purchases at a Bass Pro Shops® merchant.

It should be noted that although various embodiments are described in the context of consumers making purchases as merchant locations, the same or similar processes may be performed in order to define microsegments and/or determine groups of consumers based on remote payment transactions. For example, information regarding, e.g., the geographic location of consumers that make online purchases from online merchants may also be leveraged to define a microsegment based on behavioral variables or determine purchasing habits of a group(s) of consumers. This information, as described above, may in turn be utilized in a similar manner to correlate such purchasing habits to a channel so that the media provider of the channel can take steps to place that channel in a channel lineup slot near an anchor or other channel that is associated with high viewership. Moreover, and as described above, channel placement need not be based on anchor/popular channels but, alternatively or in addition thereto, may be based on other variables/criteria such as low channel slots. Moreover, such information may be used to obtain a channel slot amongst like-branded or like-themed channels. Further still, and while various embodiments have been described in the context of channel placement based on geographical location-based channel lineups, channel placement can be effectuated in the context of channel lineups based upon other variables, parameters, factors, etc.

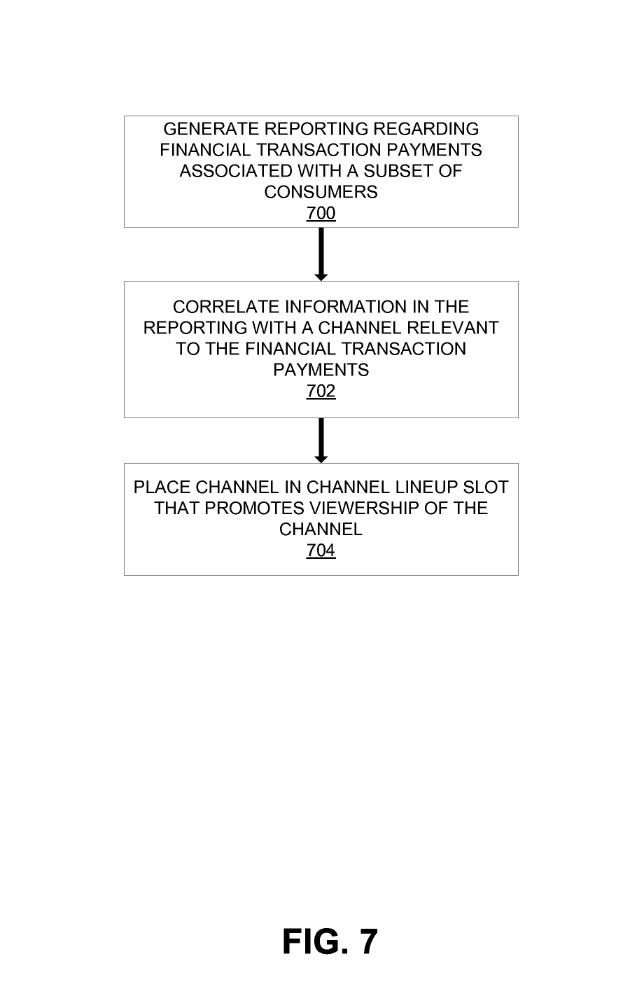

FIG. 7 is a flow chart illustrating example processes performed for achieving strategic channel placement based on purchasing information in accordance with various embodiments. At operation 700, reporting regarding financial transaction payments associated with a subset of consumers is generated. As described above, reporting may include the review and/or reporting of one or more defined microsegments, information stored in an enriched and/or other informational database, or a combination thereof that is related to some subset of consumers. The subset of consumers may be determined in view of one or more of demographics, geographical location, behavioral variables, etc. At operation 702, information in the reporting is correlated with a channel relevant to at least one of the financial transaction payments. That is, associative keywords and/or other identifiers may be mapped or otherwise matched to programming, such as a cable channel or other media channel that is commensurate with an area or subject matter of interest identified in the reporting. For example, information in the reporting may indicate that consumers in a particular geographical region make frequent purchases at a particular merchant that sells products and/or services directed to a particular area or subject matter of interest. At operation 704, the relevant channel is placed in a channel lineup slot that promotes viewership of that channel. In accordance with one embodiment, channel placement is based upon proximity to an anchor channel or other popular channel within the relevant geographical region. In accordance with another embodiment, channel placement may be based upon a low channel lineup slot or other highly viewed channel lineup section. In accordance with still another embodiment, channel placement can be based on proximity to like-branded or like-themed channels.

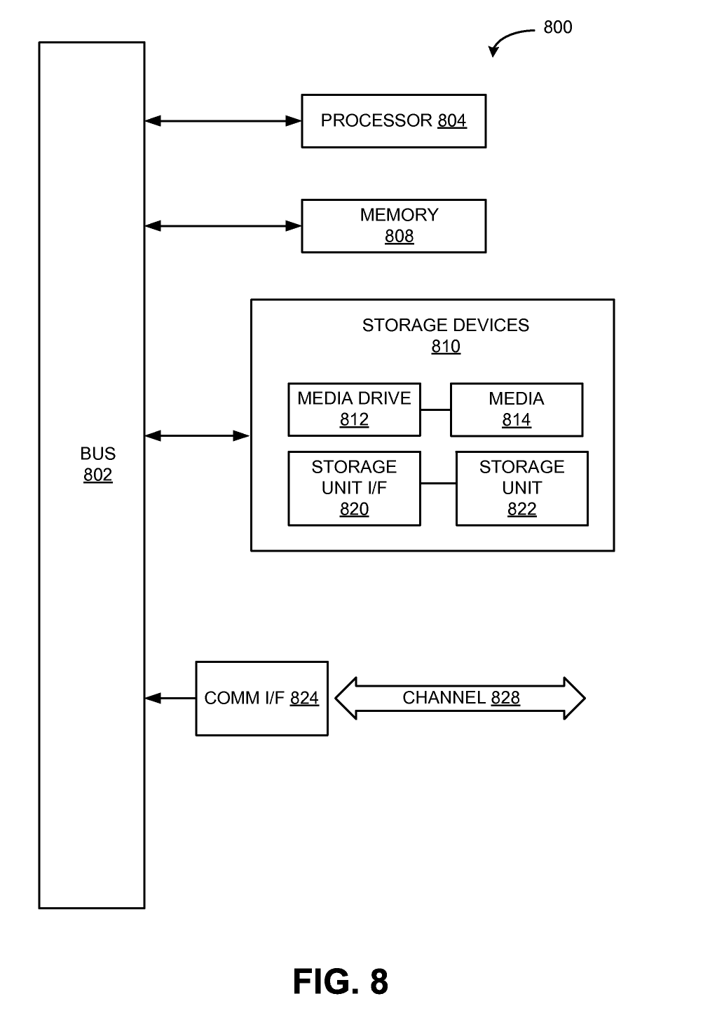

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

FIG. 8 illustrates an example computing module 800, an example of which may be processor 118, which may be used to implement various features and/or functionality of the systems and methods disclosed in the present disclosure. Computing module 800 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally.

Computing module 800 might also include one or more memory modules, simply referred to herein as main memory 808. For example, preferably random access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device coupled to bus 802 for storing static information and instructions for processor 804.

The computing module 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD or DVD drive (R or RW), or other removable or fixed media drive might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing module 800. Such instrumentalities might include, for example, a fixed or removable storage unit 822 and a storage unit interface 820. Examples of such storage units 822 and storage unit interfaces 820 can include a program cartridge and cartridge interface, a removable memory (for example, a flash memory or other removable memory module) and memory slot, a PCMCIA slot and card, and other fixed or removable storage units 822 and storage unit interfaces 820 that allow software and data to be transferred from the storage unit 822 to computing module 800.

Computing module 800 might also include a communications interface 824. Communications interface 824 might be used to allow software and data to be transferred between computing module 800 and external devices. Examples of communications interface 824 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 824 might typically be carried on signals, which can be electronic, electromagnetic (which includes optical) or other signals capable of being exchanged by a given communications interface 824. These signals might be provided to communications interface 824 via a channel 828. This channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, storage unit 820, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
generating reporting regarding financial transaction payments associated with a subset of consumers;
correlating information in the reporting with a channel relevant to the financial transaction payments; and
placing the channel in a channel lineup slot that promotes viewership of the channel.

2. The method of claim 1, wherein the reporting comprises a review of at least one microsegment representative of the subset of consumers.

3. The method of claim 2, wherein the review of the at least one microsegment comprises at least one of a review of financial account information associated with each of the subset of consumers, performing a statistical analysis on the financial account information, finding one or more correlations between the financial account information and behaviors of the subset of consumers, and predicting future behaviors of the subset of consumers.

4. The method of claim 2, wherein the at least one microsegment is defined based upon at least one of a demographical limitation and a geographical limitation.

5. The method of claim 1, wherein the correlating of the information with the channel comprises determining a subject matter of interest from the financial transaction payments based upon at least one of a product or service type associated with a merchant that is the object of the financial transaction payments and matching the at least one of the product or service type to programming presented on the channel relevant to the subject matter of interest.

6. The method of claim 1, wherein the information in the reporting comprises at least one of financial transaction payment amounts, a location of the financial transaction payments, and one or more merchants to which the financial transaction payments are made.

7. The method of claim 6, wherein the information excludes personally identifiable information associated with each of the subset of consumers.

8. The method of claim 1, wherein the placement of the channel in the channel lineup slot comprises placement proximate to an anchor channel.

9. The method of claim 1, wherein the placement of the channel in the channel lineup slot comprises placement proximate to at least one of like-branded and like-themed channels.

10. The method of claim 1, wherein the placement of the channel in the channel lineup slot comprises placement in a low channel lineup slot.

11. A non-transitory computer-readable medium having computer executable program code embodied thereon, the computer executable program code configured to cause a computer system to:
collect financial transaction payment information associated with a plurality of consumers;
define at least one microsegment representative of a subset of the plurality of consumers;
perform statistical analysis on the financial transaction payment information of the at least one microsegment to identify at least one subject matter of interest relevant to the at least one microsegment;
correlate the at least one subject matter of interest with a media channel; and
place the media channel in a media channel lineup slot that promotes viewership of the media channel.

12. The non-transitory computer-readable medium of claim 11, wherein the statistical analysis comprises at least one of a review of financial account information associated with at the at least one microsegment, performing a statistical analysis on the financial account information, finding one or more correlations between the financial account information and behaviors of the at least one microsegment, and predicting future behaviors of the at least one microsegment.

13. The non-transitory computer-readable medium of claim 11, wherein the financial transaction payment information comprises at least one of financial transaction payment amounts, a location of the financial transaction payments, and one or more merchants to which the financial transaction payments are made.

14. The non-transitory computer-readable medium of claim 11, wherein the at least one microsegment is defined based upon at least one of a demographical limitation and a geographical limitation.

15. The non-transitory computer-readable medium of claim 11, wherein the identifying of the at least one subject matter of interest comprises determining the at least one subject matter of interest from the financial transaction payment information based upon at least one of a product or service type associated with a merchant that is the object of payment.

16. The non-transitory computer-readable medium of claim 15, wherein the correlating of the at least one subject matter of interest with the media channel comprises identifying one or more keywords indicative of the product or service type associated with the merchant suggesting a relationship to programming subject matter presented on the media channel.

17. The non-transitory computer-readable medium of claim 11, wherein the identifying of the at least one subject of interest comprises identifying one or more keywords in a name of at least one merchant associated with the financial transaction payment information.

18. The non-transitory computer-readable medium of claim 17, wherein the correlating of the at least one subject matter of interest with the media channel comprises matching the identified one or more keywords to one or more keywords associated with the media channel.

19. The non-transitory computer-readable medium of claim 11, wherein financial transaction payment information excludes personally identifiable information associated with each of the plurality of consumers.

20. The non-transitory computer-readable medium of claim 11, wherein the placement of the media channel in the media channel lineup slot comprises one of placement proximate to an anchor channel, placement proximate to at least one of like-branded and like-themed channels, and placement in a highly viewed channel lineup section.
